(19) United States
(12) Patent Application Publication
(10) Pub. No.: US 2024/0429611 A1
(43) Pub. Date: Dec. 26, 2024

(54) BROADBAND PATCH ANTENNA

(71) Applicant: QUALCOMM Incorporated, San Diego, CA (US)

(72) Inventors: Assaf AVIV, Carlsbad, CA (US); Jeongil Jay KIM, San Diego, CA (US)

(21) Appl. No.: 18/340,750

(22) Filed: Jun. 23, 2023

(51) Int. Cl. H01Q 9/04; H01Q 5/364; H01Q 21/30

(52) U.S. Cl. CPC H01Q 9/0414; H01Q 5/364; H01Q 21/30; H01Q 1/243

(57) ABSTRACT

Radio frequency antenna designs for mobile devices are provided. An example patch antenna element includes an active element comprising a square metallic patch disposed on a first plane, a plurality of metallic patches disposed on a second plane that is above and parallel to the first plane, wherein each of the plurality of metallic patches are separated from one another in the second plane by a gap, and a plurality of via structures disposed between the first plane and the second plane, wherein each of the plurality of via structures is configured to electrically couple a respective one metallic patch of the plurality of metallic patches with the active element.

### BACKGROUND

A wireless device (e.g., a cellular phone or a smart phone) may include a transmitter and a receiver coupled to an antenna to support two-way communication. The antenna may be enclosed within a housing assembly (e.g., cover) based on portability and aesthetics design considerations. In general, the transmitter may modulate a radio frequency (RF) carrier signal with data to obtain a modulated signal, amplify the modulated signal to obtain an output RF signal having the proper power level, and transmit the output RF signal via the antenna to a base station. For data reception, the receiver may obtain a received RF signal via the antenna and may condition and process the received RF signal to recover data sent by the base station. As the radio frequency used by the wireless device increases, the complexity of the RF transmitting circuitry also increases. To facilitate and/or enable wireless signal applications, numerous types of antennas have been developed, with different antennas used based on the needs of an application, e.g., distance, frequency, operational frequency bandwidth, antenna pattern beam width, gain, beam steering, etc. Newer RF technologies and wireless devices are becoming more reliant on dual-band performance and may require increased frequency bandwidth performance.

### SUMMARY

An example patch antenna according to the disclosure includes an active element comprising a metallic patch disposed on a first plane, a plurality of metallic patches disposed on a second plane that is above and parallel to the first plane, wherein each of the plurality of metallic patches are separated from one another in the second plane by a gap, and a plurality of via structures disposed between the first plane and the second plane, wherein each of the plurality of via structures is configured to electrically couple a respective one metallic patch of the plurality of metallic patches with the active element.

An example patch antenna array according to the disclosure includes a plurality of high-band patch antennas configured to radiate, when electrically driven, at frequencies in a relatively higher frequency band, wherein each patch antenna of the plurality of high-band patch antennas includes an active element, a plurality of parasitic patches disposed above the active element, and a plurality of via structures configured to electrically couple a respective one parasitic patch of the plurality of parasitic patches with the active element, and a plurality of low-band patch antennas configured to radiate, when electrically driven, at frequencies in a relatively lower frequency band, the plurality of low-band patch antennas disposed in an interleaved arrangement with the plurality of high-band patch antennas, along a long axis of the patch antenna array.

An example patch antenna array according to the disclosure includes a plurality of high-band patch antennas configured to radiate, when electrically driven, at frequencies in a relatively higher frequency band, wherein each patch antenna of the plurality of high-band patch antennas includes an active element, a plurality of parasitic patches disposed above the active element, and a plurality of via structures configured to electrically couple a respective one parasitic patch of the plurality of parasitic patches with the active element, a plurality of low-band patch antennas configured to radiate, when electrically driven, at frequencies in a relatively lower frequency band, the plurality of low-band patch antennas disposed in an interleaved arrangement with the plurality of high-band patch antennas, along a long axis of the patch antenna array, wherein each low-band patch antenna of the plurality of low-band patch antennas includes: a low-band active element, and a passive element comprising a metal ring with an outer edge and an inner edge, the inner edge defining an inner opening.

Items and/or techniques described herein may provide one or more of the following capabilities, as well as other capabilities not mentioned. A patch antenna array in a mobile device may include interleaved low-band and high-band elements. The low band elements may be configured for operational frequencies up to 30 GHz, and the high-band elements may be configured for operational frequencies in the range of 37 GHz to 43.5 GHZ, and 47.2 GHz to 48.2 GHz. An example high-band patch antenna design may include parasitic patches for each active element. The parasitic patches may each be divided into smaller patches for electromagnetic coupling between the smaller patches. Dividing the parasitic patches enables improved gain performance over a wider bandwidth. Other capabilities may be provided, and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 shows a wireless device capable of communicating with different wireless communication systems.

FIG. 2 shows a wireless device with a 2-dimensional (2-D) antenna system.

FIG. 3 shows a wireless device with a 3-dimensional (3-D) antenna system.

FIG. 4 shows an exemplary design of a patch antenna.

FIG. 5 shows a side view of an example patch antenna array in a wireless device.

FIG. 6A shows a side view of an example patch antenna array in a wireless device.

FIG. 6B shows a perspective view of multiple antenna modules in a wireless device.

FIG. 7A is a perspective-view illustration of an active element, in the form of a rectangular patch, that may be used as part of an embodiment patch antenna illustrated in FIG. 7B.

FIG. 7B is a perspective-view illustration of an embodiment patch antenna.

FIG. 7C is a top-view illustration of the active element shown in FIG. 7A, together with a plurality of peripheral, passive, metallic elements disposed around on the outer edge of the active element.

FIG. 7D is a top-view illustration of an embodiment patch antenna employed for low-band performance, and a high-band patch antenna, situated adjacently to form a dual-band patch antenna.

FIGS. 8A, 8B, and 8C are a perspective-view, a top-view and a side-view of a high-band patch antenna element including a parasitic patch divided into smaller patches for electromagnetic coupling between the smaller patches.

FIGS. 8D, 8E and 8F are top-views of broadband patch antennas with variations on parasitic patch configurations.

FIG. 9A is a top-view illustration of an example patch antenna employed for low-band performance and increased frequency bandwidth performance in high-bands, situated adjacently to form a dual-band patch antenna.

FIG. 9B is a top-view illustration of an example multiband antenna with an interleaved low-band and high-band element array.

FIG. 9C is a side-view illustration of the example multiband antenna of FIG. 9B.

FIG. 10 is a flow diagram illustrating an example procedure for constructing an embodiment patch antenna.

The foregoing will be apparent from the following more particular description of example embodiments, as illustrated in the accompanying drawings, in which like reference characters refer to the same parts throughout the different views. The drawings are not necessarily to scale, emphasis instead being placed upon illustrating embodiments.

### DETAILED DESCRIPTION

This disclosure generally relates to the design of patch antennas. Particular patch antennas consistent with the disclosure can have special advantages when incorporated into dual-band patch antenna arrays, and more especially in dual-band interleaved patch antenna arrays. Certain advantages, however, may be achieved even when such patch antennas are not incorporated into a dual-band array. For example, efficiency at certain frequencies and/or bandwidth may be improved. Embodiments can be used in 5G MMW antenna arrays and modules. Nonetheless, embodiments can be useful to improve multiband aperture shared interleaved MMW antenna arrays.

Millimeter-wave (MMW) 5G antenna modules are being integrated within wireless user devices such as cell phones. It is very desirable to maximize the coverage radiated performance of the modules within the limited volume available in a wireless device. Thus, as one aspect of a solution to the coverage problem, cell phones typically integrate a few of these MMW modules to provide the best possible coverage in all surrounding directions.

Various other design constraints are also arising. For example, band support requirements for these antenna modules continue to increase as more bands are being auctioned and made available. Accordingly, there is the need to find solutions that enable the new bands, in addition to the legacy bands, within the same user devices. Moreover, thinner cell phones are being sought by cell phone customers, resulting in a need for narrower MMW modules, such as including substrates having widths less than or equal to 3.2 millimeters (<=3.2 mm). In one example, because of this size constraint, some quad-fed patch antenna arrays may use dielectric material of higher dielectric constant Dₖ to reduce the physical size of a substrate incorporating the dielectric material. Some drawbacks of higher Dₖ, quad-fed patch antenna array designs, however, may include various issues such as narrower bandwidth, a tendency toward higher coupling between bands, and limitations on the ability to optimize low-band and high-band patch antenna elements separately.

Alternatively, a multiband phased array configuration can be used in a patch antenna array with low-band and high-band patch antenna elements interleaved. In a multiband interleaved array, separate elements may be used for different bands. In other words, different, respective patch antennas may be used for respective bands or respective groups of bands. Interleaved patch antenna arrays have an advantage over quad-fed patch arrays in terms of expanding bandwidth and optimizing each low-band and high-band element separately.

However, it has been found that interleaved arrays may have reduced frequency bandwidth for new bands, such as n262 (i.e., 47.2 GHZ-48.2 GHZ). Embodiments described herein provide a new patch antenna design (which may be used in an interleaved antenna array) to improve bandwidth performance. The patch designs provided herein may support legacy bands (e.g., low band up to 30 GHz and high band in the range of 37 GHz to 43.5 GHZ), as well as newer bands, such as n262. In an example patch design, a high band array may include parasitic patches for each active element. The parasitic patches may each be divided into smaller patches for electromagnetic coupling between the smaller patches. Dividing the parasitic patches enables additional bandwidth enhancements. The smaller patches may be connected to the active patch with vias structures to increase coupling. Each of the smaller patches may receive more power via direct connection as compared to prior coupling techniques.

As used herein, “low band” (or “relatively lower band”) and “high band” (or “relatively higher band”) refer to respective bands of relatively lower-frequency and relatively higher-frequency gain regions in a multiband patch antenna array such as a dual-band patch antenna array. Consistently, one example low band that can be used in embodiments is centered in a range of 24.25-29.5 GHZ (e.g., the 28 GHz band), and one example high band that can be used in embodiments is centered in a range of 37-43.5 GHZ (e.g., the 39 GHz band) as well as in a range of 47.2 GHz to 48.2 GHz (e.g., the n262 band). However, embodiments are not limited to these bands. Further, embodiments are also not limited to only two bands, but may be more generally multiband, having two or more bands provided by two or more patch antennas.

As used herein, “rectangular” encompasses the special case of a “square,” with “square” denoting four substantially equilateral sides oriented with adjacent sides being at right angles with respect to one another.

As used herein, a second item being “disposed above” a first item denotes that the first and second items are substantially parallel to each other in particular respective planes defined by the respective first and second items and displaced from each other in a direction perpendicular to the particular planes, with at least some overlap of the first and second items when viewed perpendicular to the respective planes.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C,” or “A, B, or C, or a combination thereof” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Components, functional or otherwise, shown in the figures and/or discussed herein as being connected, coupled (e.g., communicatively coupled), or communicating with each other are operably coupled. That is, they may be directly or indirectly, wired and/or wirelessly, connected to enable signal transmission between them.

“About” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

In particular, example length and width measurements are given for embodiment patch antennas and patch antenna arrays herein. In using the term “about” or “approximately” in reference to these measurements, tolerance indicated by these terms can be readily ascertained by those of skill in the art, in view of this description, based on (i) the frequency band to be produced by a given patch, (ii) a degree of need to optimize the center of the frequency band for greatest overall gain in the intended band, and (iii) interaction of the length and width measurements with other features of the patch antenna itself, or surrounding features, that can affect frequency band.

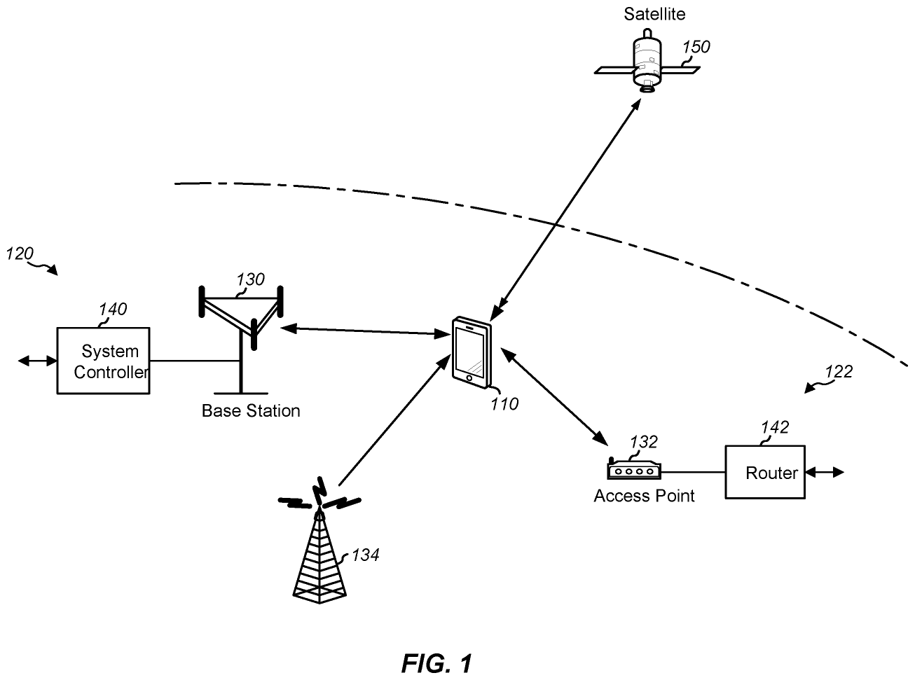

Referring to FIG. 1, a wireless device 110 capable of communicating with different wireless communication systems 120 and 122 is shown. The wireless system 120 may be a Code Division Multiple Access (CDMA) system (which may implement Wideband CDMA (WCDMA), cdma2000, or some other version of CDMA), a Global System for Mobile

Communications (GSM) system, a Long Term Evolution (LTE) system, a 5G system, etc. The wireless system 122 may be a wireless local area network (WLAN) system, which may implement IEEE 802.11, etc. For simplicity, FIG. 1 shows the wireless system 120 including a base station 130 and a system controller 140, and the wireless system 122 including an access point 132 and a router 142. In general, each system may include any number of stations and any set of network entities.

The wireless device 110 may also be referred to as a user equipment (UE), a mobile device, a mobile station, a terminal, an access terminal, a subscriber unit, a station, etc. The wireless device 110 may be a cellular phone, a smart phone, a tablet, a wireless modem, a personal digital assistant (PDA), a handheld device, a laptop computer, a smart book, a netbook, a cordless phone, a wireless local loop (WLL) station, an internet of things (IoT) device, a medical device, a device in an automobile, a Bluetooth device, etc. The wireless device 110 may be equipped with any number of antennas. Multiple antennas may be used to provide better performance, to simultaneously support multiple services (e.g., voice and data), to provide diversity against deleterious path effects (e.g., fading, multipath, and interference), to support multiple-input multiple-output (MIMO) transmission to increase data rate, and/or to obtain other benefits. The wireless device 110 may be capable of communicating with one or more wireless systems 120 and/or 122. The wireless device 110 may also be capable of receiving signals from broadcast stations (e.g., a broadcast station 134). The wireless device 110 may also be capable of communicating with satellites (e.g., a satellite 150), for example in receiving signals in one or more global navigation satellite systems (GNSS) and/or transmitting signals to satellites in other systems. Further, the wireless device 110 may be configured to communicate directly with other wireless devices (not illustrated), e.g., without relaying communications through a base station or access point or other network device.

In general, the wireless device 110 may support communication with any number of wireless systems, which may employ any radio technologies such as WCDMA, cdma2000, LTE, 5G, GSM, 802.11, GPS, etc. The wireless device 110 may also support operation on any number of frequency bands.

The wireless device 110 may support operation at a very high frequency, e.g., within millimeter-wave (MMW) frequencies from 24 to 300 gigahertz (GHz) or higher. For example, the wireless device 110 may be capable to operate with dual (or more) bands. One such configuration includes the 28 GHz, 39 GHz and n262 bands. Other very high frequency (e.g., 5G) bands, such as 60 GHz or higher frequency bands, may also be realized with the wireless device 110 and implemented as one of the bands. The wireless device 110 may include an antenna system to support CA operations at MMW frequencies. The antenna system may include a number of antenna elements, with each antenna element being used to transmit and/or receive signals. The terms “antenna” and “antenna element” are synonymous and are used interchangeably herein. Generally, each set of antenna elements may be implemented with a patch antenna or a strip-shaped radiator. A suitable antenna type may be selected for use based on the operating frequency of the wireless device, the desired performance, etc. In an exemplary design, an antenna system may include a number of patch and/or strip-type antennas supporting operation at MMW frequencies.

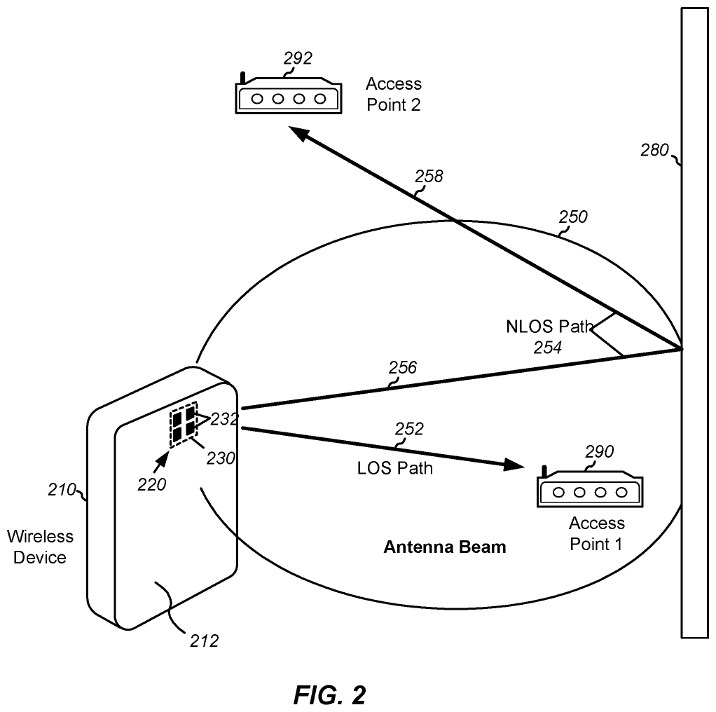

Referring to FIG. 2, an exemplary design of a wireless device 210 with a 2-D antenna system 220 is shown. In this exemplary design, antenna system 220 includes a 2×2 array 230 of four patch antennas 232 (i.e., radiators) formed on a single geometric plane corresponding to a back surface of wireless device 210 (e.g., a backside array). Those of skill in the art will understand that other array configurations may be utilized. For example, a 1×4 array may be used or an array with a greater number of columns and/or rows may be used.

While the antenna system 220 is visible in FIG. 2, in operation the patch array may be disposed on a PC board, antenna carrier, or other assembly located on an inside surface of a device or cover 212. The patch antenna array 230 has an antenna beam 250, which may be formed to point in a direction that is orthogonal to the plane on which patch antennas 232 are formed or in a direction that is within a certain angle of orthogonal, for example up to 60 degrees in a direction from orthogonal. Wireless device 210 can transmit signals directly to other devices (e.g., access points) located within antenna beam 250 and can also receive signals directly from other devices located within antenna beam 250. Antenna beam 250 thus represents a line-of-sight (LOS) coverage of wireless device 210.

An antenna element may be formed on a plane corresponding to a surface of a wireless device and may be used to transmit and/or receive signals. The antenna element may have a particular antenna beam pattern and a particular maximum antenna gain, which may be dependent on the design and implementation of the antenna element. Multiple antenna elements may be formed on the same plane and used to improve antenna gain. Higher antenna gain may be especially desirable at MMW frequency since (i) it is difficult to efficiently generate high power at MMW frequency and (ii) attenuation loss may be greater at MMW frequencies.

For example, an access point 290 (i.e., another device) may be located inside the LOS coverage of wireless device 210. Wireless device 210 can transmit a signal to access point 290 via a line-of-sight (LOS) path 252. Another access point 292 may be located outside the LOS coverage of wireless device 210. Wireless device 210 can transmit a signal to access point 292 via a non-line-of-sight (NLOS) path 254, which includes a direct path 256 from wireless device 210 to a wall 280 and a reflected path 258 from wall 280 to access point 292.

In general, the wireless device 210 may transmit a signal via a LOS path directly to another device located within antenna beam 250, e.g., as shown in FIG. 2. Ideally, this signal may have a much lower power loss when received via the LOS path. The low power loss may allow wireless device 210 to transmit the signal at a lower power level, which may enable wireless device 210 to conserve battery power and extend battery life.

The wireless device 210 may transmit a signal via a NLOS path to another device located outside of antenna beam 250, e.g., as also shown in FIG. 2. This signal may have a much higher power loss when received via the NLOS path, since a large portion of the signal energy may be reflected, absorbed, and/or scattered by one or more objects in the NLOS path. Wireless device 210 may transmit the signal at a high power level in an effort to ensure that the signal can be reliably received via the NLOS path.

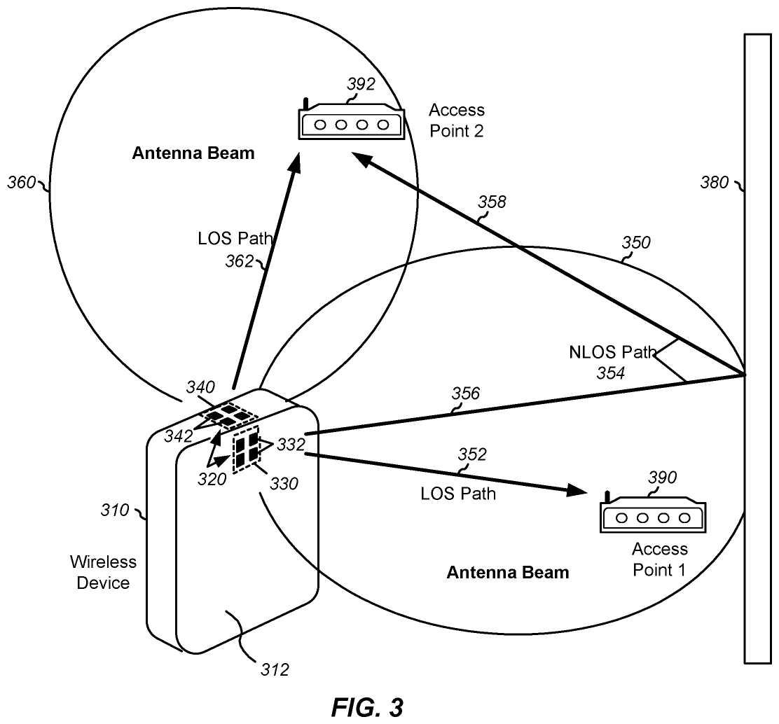

Referring to FIG. 3, an exemplary design of a wireless device 310 with a 3-D antenna system 320 is shown. In this exemplary design, antenna system 320 includes (i) a 2×2 array 330 of four patch antennas 332 formed on a first plane corresponding to the back surface of wireless device 310 and (ii) a 2×2 array 340 of four patch antennas 342 formed on a second plane corresponding to the top surface of wireless device 310 (e.g., a device edge or an end-fire array). The patch antenna arrays 330, 340 are disposed on the inside of a device cover 312. The antenna array 330 has an antenna beam 350, which points in a direction that is orthogonal to the first plane on which patch antennas 332 are formed. Antenna array 340 has an antenna beam 360, which points in a direction that is orthogonal to the second plane on which patch antennas 342 are formed. In an example, the arrays 330 and 340 may point in a direction that is within a certain angle of orthogonal, for example up to 60 degrees in a direction from orthogonal. Antenna beams 350 and 360 thus represent the LOS coverage of wireless device 310. While the arrays 330 and 340 are each illustrated as a 2×2 array in FIG. 3, one or both may include a greater or fewer number of antennas, and/or the antennas may be disposed in a different configuration. For example, one or both of the arrays 330 and 340 may be configured as a 1×4, 1×5, 1×8, 2×4 or other array dimensions.

An access point 390 (i.e., another device) may be located inside the LOS coverage of antenna beam 350 but outside the LOS coverage of antenna beam 360. Wireless device 310 can transmit a first signal to access point 390 via a LOS path 352 within antenna beam 350. Another access point 392 may be located inside the LOS coverage of antenna beam 360 but outside the LOS coverage of antenna beam 350. Wireless device 310 can transmit a second signal to access point 392 via a LOS path 362 within antenna beam 360. Wireless device 310 can transmit a signal to access point 392 via a NLOS path 354 composed of a direct path 356 and a reflected path 358 due to a wall 380. Access point 392 may receive the signal via LOS path 362 at a higher power level than the signal via NLOS path 354.

The wireless device 310 shows an exemplary design of a 3-D antenna system comprising two 2×2 antenna arrays 330 and 340 formed on two planes (e.g., backside and edge or end-fire arrays). In general, a 3-D antenna system may include any number of antenna elements formed on any number of planes pointing in different spatial directions. The planes may or may not be orthogonal to one another. Any number of antennas may be formed on each plane and may be arranged in any formation. The antenna arrays 330, 340 may be formed in an antenna carrier substrate and/or within the device cover 312.

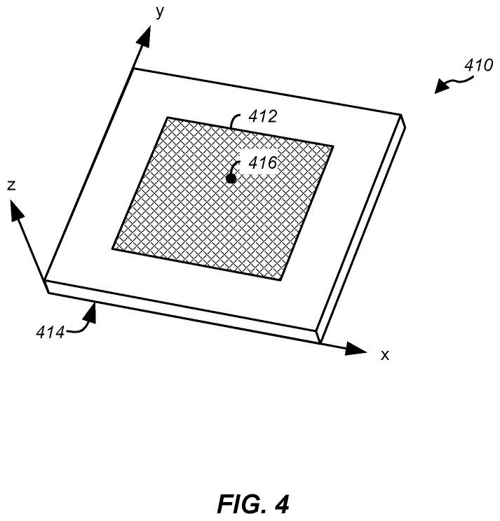

Referring to FIG. 4, an exemplary design of a patch antenna 410 suitable for MMW frequencies is shown. The patch antenna 410 includes a radiator such as a conductive patch 412 formed over a ground plane 414. In an example, the patch 412 has a dimension (e.g., 2.5×2.5 mm) selected based on the desired operating frequency. The ground plane 414 has a dimension (e.g., 4.0×4.0 mm) selected to provide the desired directivity of patch antenna 410. A larger ground plane may result in smaller back lobes. In an example, a feed point 416 is located near the center of patch 412 and is the point at which an output RF signal is applied to patch antenna 410 for transmission. Multiple feed points may also be used to vary the polarization of the patch antenna 410. For example, at least two conductors may be used for dual polarization (e.g., a first conductor and a second conductor may be used for a horizontal-pol feed line and a vertical-pol feed line). The locations and number of the feed points may be selected to provide the desired impedance match to a feedline. Additional patches may be assembled in an array (e.g., 1×2, 1×3, 1×4, 1×5, 2×2, 2×3, 2×4, 3×3, 3×4, etc . . . ) to further provide a desired directivity and sensitivity. The ground plane 414 may be disposed under all of the patches in the array.

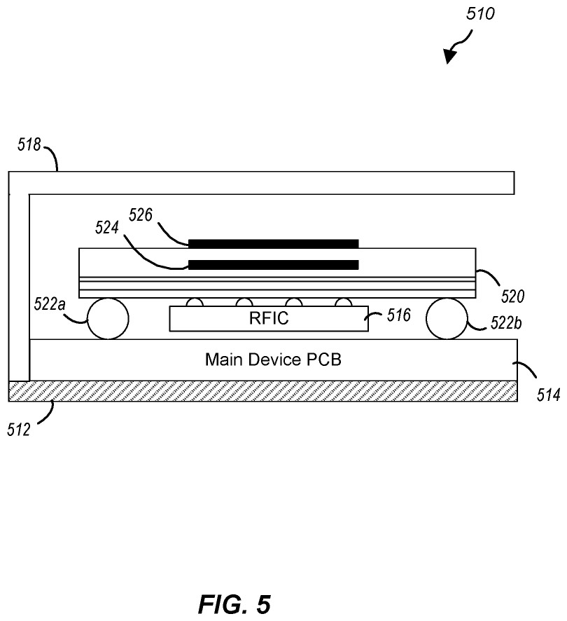

Referring to FIG. 5, a side view of an example patch antenna array in a wireless device 510 is shown. The wireless device 510 includes a display device 512, a device cover 518, and a main device printed circuit board (PCB) 514. The main device PCB 514 may be at least one printed circuit board or a plurality of printed circuit boards. In the embodiment illustrated in FIG. 5, a MMW module PCB 520 is operably coupled to the main device PCB 514 via at least one conductor 522a-b, which may be configured as one or more ball grid arrays (BGA). The BGA may be configured to enable one or more signals to flow between the MMW module PCB 520 and the main device PCB 514. The MMW module PCB 520 may include at least one patch antenna array 524 and corresponding passive patches 526 to form a wideband antenna. The MMW module PCB 520 also includes signal and ground layers in the illustrated embodiment. At least one radio frequency integrated circuit (RFIC) 516 may be mounted to the MMW module PCB 520 and operated to adjust the power and/or the radiation beam patterns associated with the patch antenna array 524. In some embodiments, the RFIC 516 is also configured to upconvert signals for transmission and/or downconvert received signals. The RFIC 516 may be an example of an antenna controller and may be configured to utilize phase shifters and hybrid antenna couplers to control the power directed to the antenna array and to control the resulting beam pattern. The MMW module PCB 520 is configured in a backside configuration in the embodiment illustrated in FIG. 5 to generate a beam on the back side (i.e., opposite the display device 512) of the wireless device 510. In some embodiments, the MMW module PCB 520 is implemented as a substrate configured as a routing layer which is formed separate from one or more of the patch antennas 524, 526 and coupled to such antennas. For example, each patch antenna 524 (and optionally including passive patch 526) may be formed as a discrete component which is coupled to the routing layer, or several different antennas may be formed together in a common stackup that is coupled to the routing layer. The size, stackup, type of material, type of antenna (e.g., patch or dipole), etc. that forms an antenna portion separate from the PCB 520 may vary between different antenna portions.

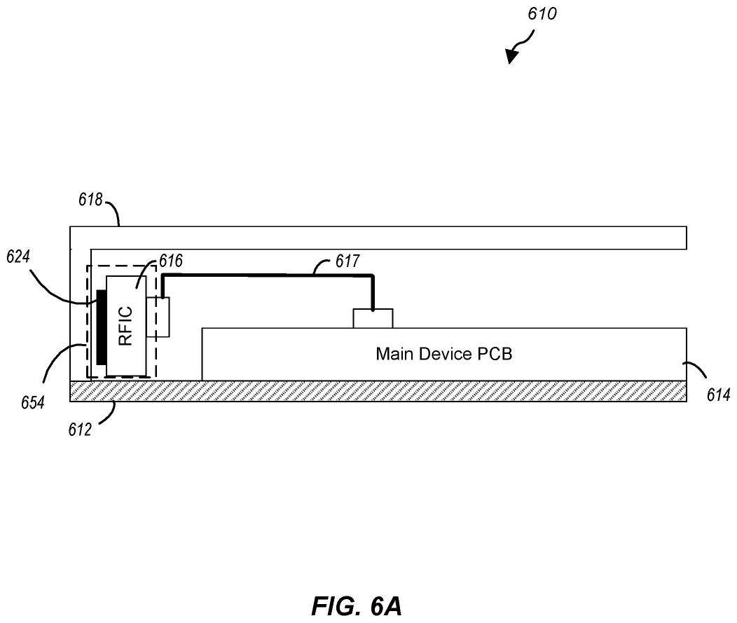

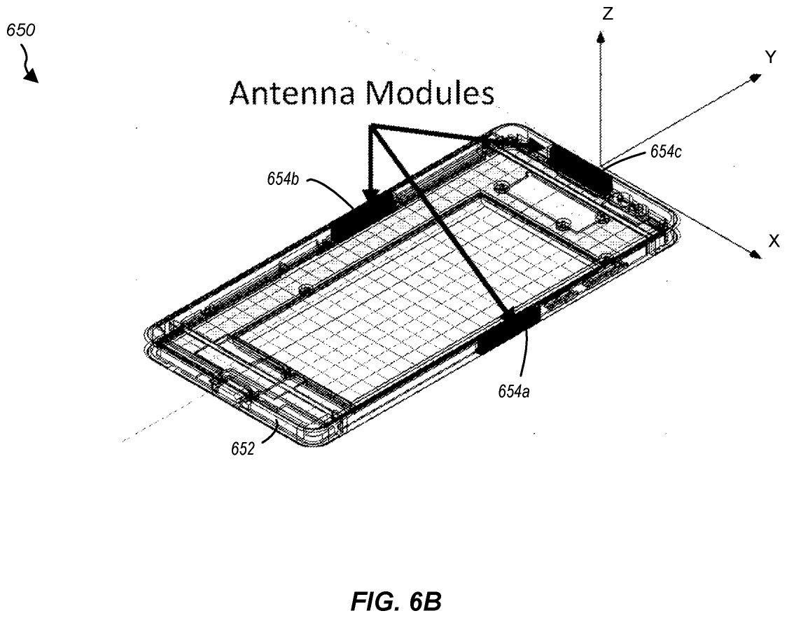

Referring to FIG. 6A, a side view of an example patch antenna array in a wireless device 610 is shown. The wireless device 610 includes a display device 612, a device cover 618, and a main device printed circuit board (PCB) 614. The main device PCB 614 may be at least one printed circuit board or a plurality of printed circuit boards. One or more antenna modules 654 may be disposed on the outer edge of the wireless device 610, for example near a top (as illustrated with the array 340 in FIG. 3), bottom, side, or back (not illustrated) of the device 610. Each of the antenna modules 654 may be operably coupled to the main device PCB 614 via one or more cabling assemblies 617. The cabling assemblies may include connectors configured to mate with one or more of the antenna modules 654 and the main device PCB 614. The antenna module 654 includes an antenna array 624 and may include at least one radio frequency integrated circuit (RFIC) 616. The RFIC 616 may be configured to adjust the power and/or the radiation beam patterns associated with the antenna array 624. The RFIC 616 is an example of an antenna controller and may be configured to utilize phase shifters and/or hybrid antenna couplers to control the power directed to the antenna array and to control the resulting beam pattern. In other examples, the antenna array 624 is disposed as illustrated, but is not packaged together with the RFIC 616 in a module. In such examples, the RFIC 616 may be physically and/or operationally coupled to, or integrated with, the main device PCB 614, and coupled to the antenna array 624 via the cable 617. The RFIC 616 may also be disposed away from the main device PCB 614, for example in another portion of an edge of the wireless device 610, and the antenna array 624, RFIC 616, and main device PCB 614 may be daisy chained together by a plurality of cables. Additional antenna modules 654 or antenna arrays may be operably coupled to the main device PCB 614 with one or more cables. While the antenna module 654 is illustrated as being disposed on the outer edge of the device 610 in FIG. 6A, those of skill in the art will appreciate that an antenna module or antenna array may be disposed elsewhere in the device. In some implementations of the embodiment illustrated in FIG. 6A, the antenna module or array is configured to emit and/or receive radiation through an edge of the device. For example, emission or reception of radiation can be in a direction that is roughly perpendicular to the portion of the device cover 618 illustrated on the left side of the figure. In some embodiments, one or more antenna modules or arrays are configured to emit and/or receive radiation through a front or back of the device 610.

Referring to FIG. 6B, a perspective-view of multiple antenna modules 654a-c in a wireless device 650 is shown. The antenna modules 654a-c are examples of the antenna modules 654 in FIG. 6A. The wireless device 650 includes a frame 652 configured to receive the antenna modules 654a-c along the edges as depicted in FIG. 6B. In general, the thickness of the edges of the wireless device 650 is being reduced in size due to market demands. For example, it is desirable for some wireless devices to have edge thicknesses that are less than 4.0 millimeters. The frame 652 may include one or more mounting assemblies configured to secure one or more antenna modules 654a-c along the edges to improve the coverage area of the wireless device 650. The multiple antenna modules 654a-c enable 3D operation, such as depicted in FIG. 3. The locations of the antenna modules 654a-c are examples, as different wireless devices may have other edge features/controls such as volume, on/off, scroll wheels, etc. which may impact the antenna configuration. In some examples, an antenna array which is not packaged into a module may be included instead of any of the antenna modules 654. In such examples, each antenna array may be coupled to a respective or common RFIC disposed on a main board of the wireless device 650.

Embodiment patch antennas and patch antenna arrays can be incorporated into the devices described hereinabove, such as into the wireless device 110 in FIG. 1, onto or into the antenna system 220 in FIG. 2, in place of the patch antenna 410 in FIG. 4, in place of the patch antennas 524 and or corresponding passive patches 526 in FIG. 5, into the antenna module 654 (or as a standalone antenna array) in FIG. 6A, and into the antenna modules 654a-c (or as one or more standalone antenna arrays) in FIG. 6B.

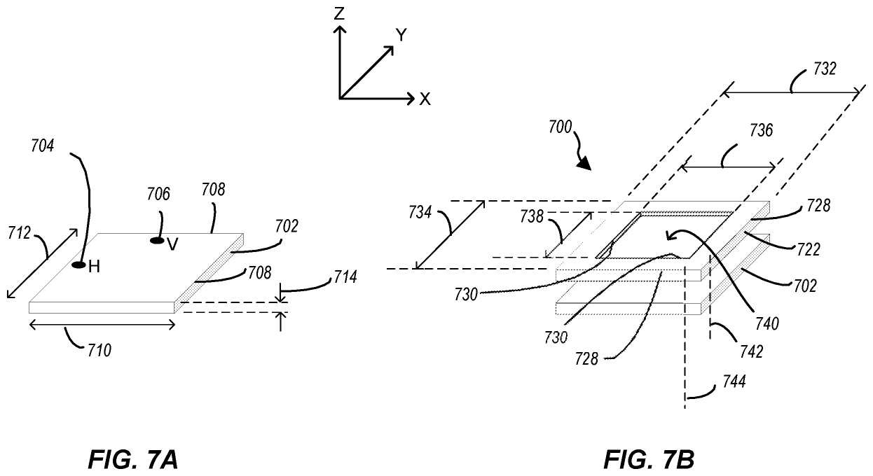

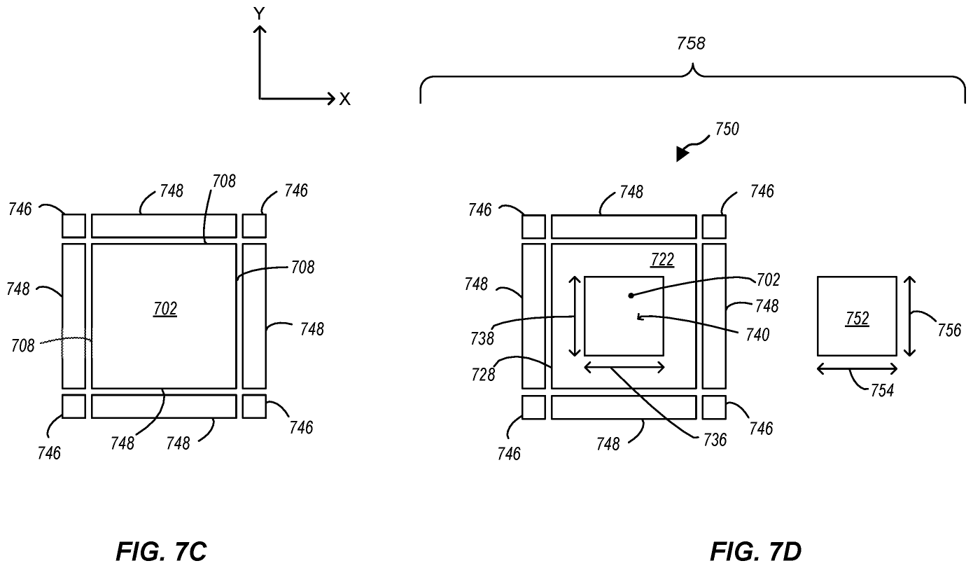

FIG. 7A is a perspective-view diagram illustrating details of an active element 702 that can be used as part of an embodiment patch antenna. The active element 702 is also referred to herein as a “metallic patch,” “patch antenna,” “rectangular patch,” and the like. The active element 702 can form part of embodiment patch antennas, including in use as low-band patch antennas in a dual-band array, that can provide benefits described hereinabove and also hereinafter. The mutually orthogonal X, Y, and Z axes are oriented similarly, with respect to patch antennas and arrays, for FIGS. 7A-7D.

Generally, the active element 702 includes a rectangular metallic patch having an outer edge 708 that is perfectly or substantially rectangular, a length 710 in the X direction shown, a width 712 in the Y direction that is shown, and a thickness (height) 714 in the Z axis direction that is shown. In the particular embodiment of FIG. 7A, the length 710 and width 712 are equal, such that the active element 702 is square, and the outer edge 708 is an outer square edge (including the portions pointed out in the drawing) that defines four equilateral sides of the square patch. In some embodiments, each of the four equilateral sides of the square patch can have both the length 710 and width 712 about 1.65 mm to be directed to the 28 GHz band. “About,” as used herein, indicates the tolerance on these example length and width measurements as described hereinabove.

In embodiments implemented in interleaved patch antenna arrays, differently sized patch antennas are directed to the higher-frequency and lower-frequency bands (higher and lower with respect to each other). For this reason, each given patch antenna in an array can preferably be configured to provide one or more particular frequency bands, and it can be preferable for the active element 702 to be square, such that the resonant frequency of the active element is the same in both orientations, as understood by those of skill in the art. Nonetheless, in other embodiments, the active element 702 can generally be rectangular, such that the length 710 and width 712 of the active element 702 are different.

Still referring to FIG. 7A, exemplary feed points 704 (horizontal polarization feed point H) and 706 (vertical polarization feed point V) are shown. The first (H) feed point 704 is disposed along one side of the outer edge 708, approximately halfway along the width 712 dimension. The second (V) feed point 706 is disposed approximately halfway along an adjacent side of the outer edge 708, corresponding to the length 710 dimension. The distances of the feed points 704, 706 from their respective edges may vary based on impedance measurements (i.e., the locations of the feed points 704, 706 may be used for impedance matching). In a general example of a rectangular active element in which the length 710 and width 712 dimensions differ, the rectangular active element will generally produce two different frequency bands, one a relatively higher band and the other a relatively lower band. In that generalized case, the two feed points 704, 706 may be utilized to excite the lower and higher bands, respectively, or vice versa, for example, depending on the relative length and width dimensions. However, in the preferred case of a square active element, as illustrated in FIG. 7A, the patch produces one frequency band, and the respective feed points may be selectively used solely on a basis of desired polarization, for example. In other embodiments, one or both of the feed points 704, 706 are disposed at a location other than halfway along its respective edge, on a basis of other desired polarizations or other factors, for example, and more or fewer than two feed points can be used based on design choices known to those of skill in the art in view of existing patch antennas. Feeds may be directly connected to the active element 702 at the points 704, 706 (or other points, as described above), or one or more feeds may be capacitively coupled to the active element 702.

FIG. 7B is a perspective-view illustration of an embodiment patch antenna 700 that includes both the active element 702, as shown in FIG. 7A, and a passive element 722. The patch antenna 700 can be referred to herein as a “low-band” patch antenna, in the sense that it is particularly useful when directed to a relatively lower-frequency band of a dual-band patch antenna array. Nonetheless, the patch antenna 700 can be configured for, and operated at, a wide range of frequency bands. The passive element 722 includes a metal ring and can be referred to herein as a “metal ring,” “metallic ring,” or simply a “ring.” The passive element 722 has an outer edge 728 and an inner edge 730, with two illustrative portions thereof specifically indicated in FIG. 7B. The outer edge 728 and the inner edge 730 define and delimit the ring of the passive element 722. The passive element 722 has an outer length 732 of the outer edge 728 and an outer width 734 of the outer edge 728. In this particular embodiment, the outer length 732 and outer width 734 are the same, such that the outer edge 728 of the passive element 722 is square. Moreover in this embodiment, the outer length 732 is the same as the length 710 of the active element 702, which is below the passive element 722. Likewise, the outer width 734 of the passive element 722 is the same as the width 712 of the active element 702. Thus, the lengths and widths of the active element 702 and passive element 722 may be approximately the same. In an embodiment directed to the 28 GHz band, the outer edge 728 being square, the outer length 732 and outer width 734 preferably can both be about 1.65 mm.

The inner edge 730 defines an inner opening 740, which extends through the passive element 722. The metal ring of the passive element 722 encompasses the inner opening 740. The inner edge 730 and inner opening 740 of the passive element 722 in FIG. 7B are rectangular (and in this embodiment, more particularly, square). However, the passive element 722, which includes a metal ring, can have inner openings of other shapes, including a circular inner opening. In yet other embodiments, the outer edge, inner edge, and inner opening may form other shapes such as ellipses, ovals, and other polygons. Given that both the outer edge 728 and the inner edge 730 are squares that are centered with respect to each other, the passive element 722 has multiple axes of symmetry. Two example axes of symmetry are in the plane defined by the outer edge 728 and inner edge 730 of the passive element 722; parallel to adjacent sides of the outer edge 728 and the inner edge 730, respectively; and pass through a center of the inner opening 740. Other example axes of symmetry may be defined between corners of the outer edge 728 or the inner edge 730. Other embodiments may have zero, one, two, or more than two axes of symmetry.

Dimensions of the inner edge 730, being rectangular (and particularly square in this case) include an inner length 736 and an inner width 738. These inner dimensions may be close to dimensions of an adjacent high-band patch element in a dual-band patch antenna, further described hereinafter in connection with FIG. 7C. In some embodiments, the inner edge 730 has the inner length 736 and the inner width 738 both being approximately 1.0 mm. In the patch antenna 700, which can function in a relatively lower-frequency band as a “low-band” patch antenna, each side of the inner edge 730, which is square in this embodiment, has the inner length 736 and the inner width 738 both about 1.0 mm.

Size of the inner opening 740, defined by the inner length 736 and the inner width 738, may affect the center of the frequency band. A compensation may be made for this effect by providing a plurality of passive, parasitic patch elements disposed around the active element 702, as illustrated in FIG. 7C. Alternatively, a compensation in frequency of the band can be provided by adjusting the size of the active element 702, (via the length 710 and width 712 dimensions), and corresponding outer length 732 and outer width 734 dimensions of the passive element 722.

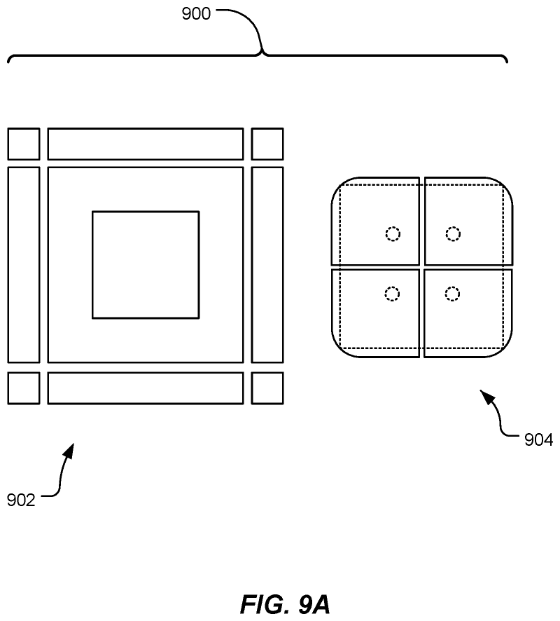

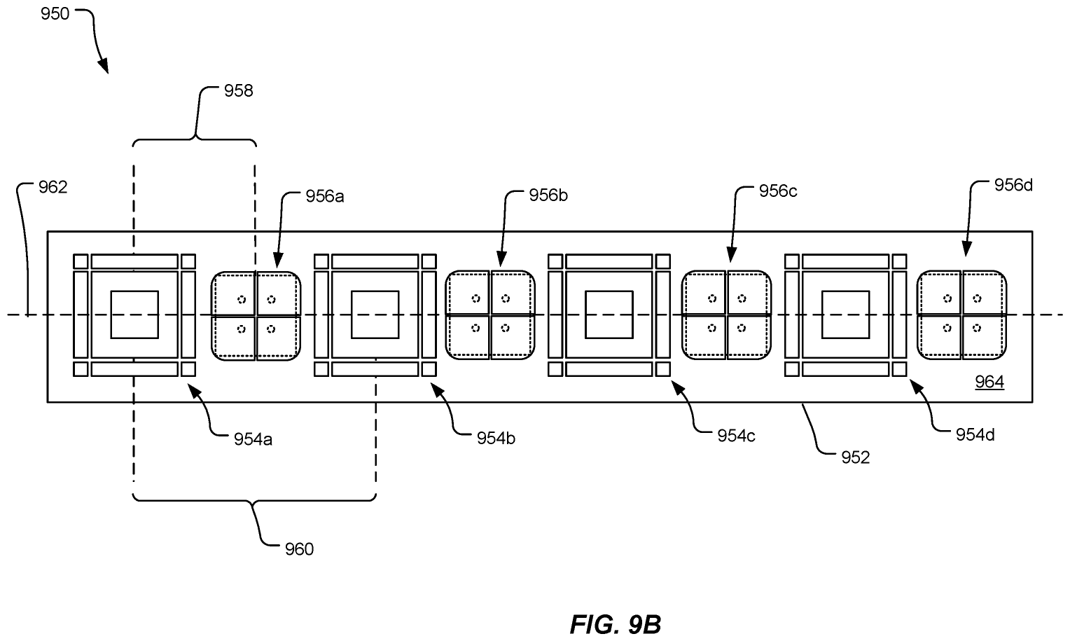

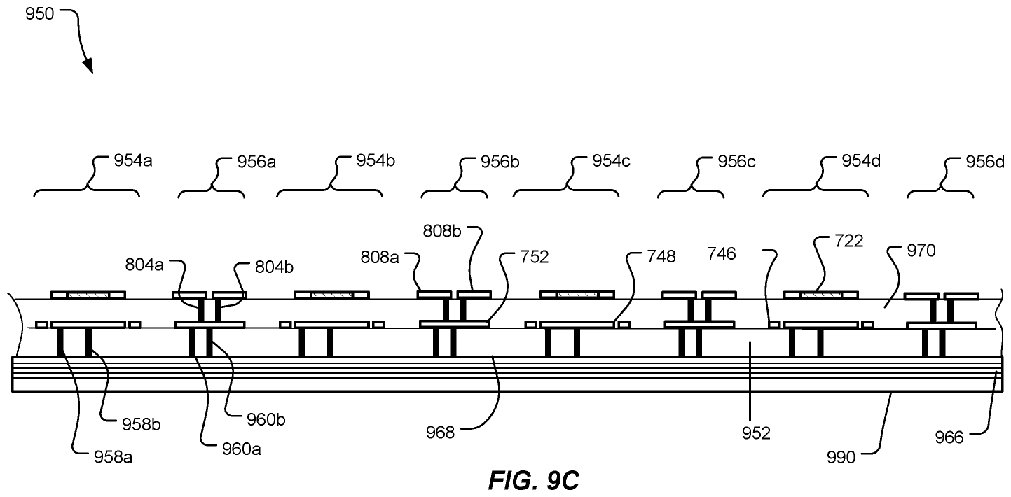

A layer of dielectric material (not shown in FIG. 7B, but illustrated further in FIG. 9C) may be disposed between the active element 702 and the passive element 722. A dielectric constant Dₖ of the dielectric material may be in a range of about 5.0 to 9.8. In particular embodiments, the dielectric constant Dₖ of the dielectric material may be in a range of about 4.4 to about 6.4, in a range of about 9.0 to about 9.8, or in a range of about 5.0 to about 9.8. More particular values of about 5.4 and about 9.4 have been demonstrated to be favorable for certain embodiments. More generally, Dₖ can be in a range about 3.0 to about 12 in various embodiments, and dimensions may be adjusted accordingly.

The passive element 722 is disposed above the active element 702. Consistent with the usage of this term herein, the active element 702 and passive element 722 are substantially parallel to each other, with planes formed by the active element 702 and passive element 722 being substantially parallel to the XY plane shown and thus being substantially parallel to each other. The active element 702 and passive element 722 are displaced from each other in the Z direction, perpendicular to the XY plane. The active element 702 and passive element 722 may have a lateral alignment 742 in the X direction, denoted by a dashed line, and a lateral alignment 744 in the Y direction, denoted by a dashed line. In the illustration shown, both alignments are perfect. Nonetheless, in various embodiments, this alignment is about or approximately perfect. In other embodiments, the outer edges 708 of the active element 702 are not aligned with the outer edges 728 of the passive element 722. For example, the active element 702 may be larger than the passive element 722. In such examples, a projection of the active element 702 in the Z direction may fully enclose the passive element 722. In other examples, outside dimensions of the passive element 722 are larger than outside dimensions of the active element 702.

FIG. 7C is a top-view illustration of the active element 702 of FIG. 7A surrounded by a plurality of peripheral, passive, metallic elements disposed around the outer edge 708 of the active element 702. In particular, in this embodiment, the plurality of peripheral, passive, metallic elements includes corner elements 746 situated at corners of the active element 702, together with side elements 748 (e.g., having an elongated or rectangular shape) situated at sides of the active element 702. The plurality of peripheral, passive, metallic elements are electrically isolated from the active element 702 and from each other. The plurality of peripheral, passive, metallic elements in various embodiments may include a total of 8 elements, as illustrated in FIG. 7C, with the corner elements 746 (e.g., having a square shape) situated symmetrically at corners of the active element 702, and with the side elements 748 situated adjacent and parallel to sides of the active element 702 around the outer edge 708 thereof. Alternatively, the plurality of peripheral, passive, metallic elements can include a total of four passive elements, or another number of passive elements, provided that the passive elements are situated symmetrically (e.g., reflectionally symmetric or rotationally symmetric) around the active element 702, or there may be a single peripheral, passive, metallic element shaped as a ring surrounding the active element 702. The plurality of peripheral, passive, metallic elements has a tendency to increase bandwidth of the active element 702 and to shift the center of the frequency band down. This can be used to compensate for a tendency of the passive element 722, illustrated in FIG. 7B, to shift up the resonant frequency band of the active element 702. (The passive element 722 and the plurality of peripheral, passive, metallic elements shown in FIG. 7D are illustrated in combination in the embodiment of FIG. 7D.) Accordingly, these effects can cancel each other, such that the overall center frequency range of the patch antenna, illustrated in FIG. 7D, may remain unchanged. The corner elements 746 and the side elements 748 are coupled with each other electromagnetically and do not have a physical, electrical connection.

FIG. 7D is a top-view diagram of an embodiment dual-band patch antenna 758, which may be considered a dual-band patch antenna of an embodiment dual-band patch antenna array. The dual-band patch antenna 758 includes an embodiment low-band patch antenna 750, directed to a relatively lower-frequency band, and a high-band patch 752, directed to a relatively higher-frequency band(s). The low-band patch antenna 750 includes the active elements 702, the plurality of peripheral, passive, metallic elements including the corner elements 746 and the side elements 748 illustrated in FIG. 7C and the passive element 722 that forms a metal ring, illustrated in FIG. 7B. Given that the passive element 722 is disposed above the active element 702, a portion of the active element 702 is visible through the inner opening 740, as indicated by a dot at the end of the active element 702 leader line.

An arrangement such as that shown in FIG. 7D has particular advantages in dual-band performance. The low-band patch antenna 750 may be optimized for low-band performance, such as gain over the 28 GHz band noted above, while the high-band patch 752 may be optimized separately for gain in the 39 GHz and 48 GHz band, as noted above. In other words, the low-band patch antenna 750, when electrically driven, may radiate in the 28 GHz band, specifically with a peak gain in a range of 24.25-29.5 GHZ. Correspondingly, the high-band patch 752 may be separately optimized for gain that is centered in a high band, for example the 39 GHz band, centered in the range of 37-43.5 GHZ, and the n262 band, centered in the range of 47.2-48.2 GHZ). The passive element 722 may have the inner opening 740, with the inner length 736 and the inner width 738, sized similarly to a length 754 and a width 756, respectively, of the high-band patch 752. Accordingly, the inner edge 730, which is illustrated in FIG. 7B, defining the inner opening 740, is sized to suppress production of radiation, by the low-band patch antenna 750, at a second harmonic of the low frequency band. Such sizing can substantially reduce coupling and interference between the elements, such as via high-band radiation from the high-band patch 752 exciting a second harmonic frequency band of the low-band patch antenna 750. This excitation may otherwise occur much more substantially without the passive element 722.

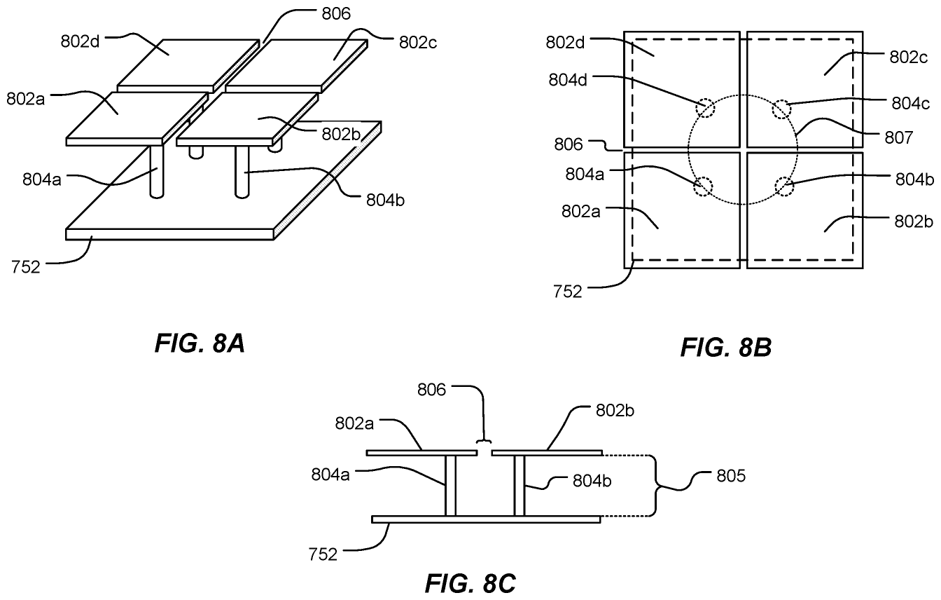

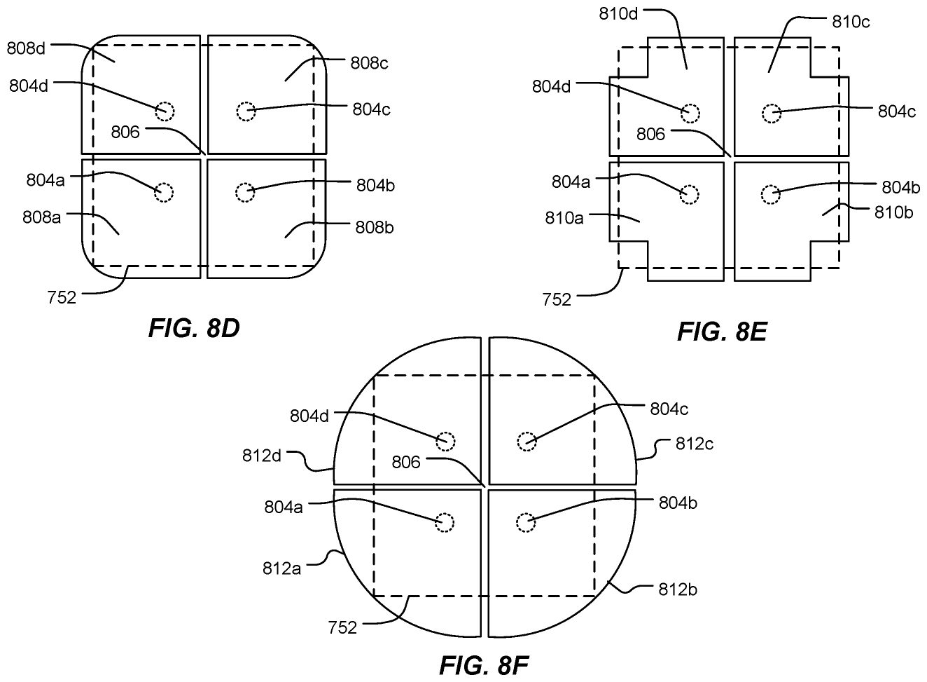

FIGS. 8A, 8B, and 8C are a perspective-view, a top-view, and a side-view, respectively, of an example high-band antenna element including the high-band patch 752 and a parasitic patch divided into smaller patches. The smaller patches may include a first patch 802a, a second patch 802b, a third patch 802c, and a fourth patch 802d. The combined surface area of the parasitic patches 802a-d is approximately (e.g., within +/−15%) the same as the surface area of the high-band patch 752. Each of the parasitic patches 802a-d are separated from one another by a gap 806 such that the parasitic patches 802a-d are not in physical contact but close enough to enable electromagnetic coupling between one or more neighboring patches. Each of the parasitic patches 802a-d are electrically connected to the high-band patch 752 (i.e., the active patch) with one or more conductive via structures. For example, the first patch 802a may be connected to a first via 804a, the second patch 802b may be connected to a second via 804b, the third patch 802c may be connected to a third via 804c, and the fourth patch 802d may be connected to a fourth via 804d. Each of the vias 804a-d are connected to the high-band patch 752. A dielectric material may be disposed in a volume 805 between the high-band patch 752 and the parasitic patches 802a-d. In an example, the dielectric constant Dₖ of the dielectric material between high-band patch 752 may be in a range of about 4.4 to about 6.4, in a range of about 9.0 to about 9.8, or in a range of about 5.0 to about 9.8. More particular values of about 5.4 and about 9.4 have been demonstrated to be favorable for certain embodiments. More generally, Dₖ can be in a range about 3.0 to about 12 in various embodiments, and dimensions may be adjusted accordingly.

In an example, the high-band patch 752 is substantially square in shape with a length and width of 1.4 mm each, but other shapes are possible. The total area covered by the parasitic patches 802a-d is approximately a square shape of 1.58 mm along each edge (including the gap 806, which may be approximately 0.05 mm across). Other dimensions may also be used based on the operational frequency of the antenna array. The size of the gap 806 between each of the parasitic patches 802a-d may vary based on the manufacturing process and is typically in a range of 0.05 mm to 0.08 mm. The parasitic patches 802a-d are disposed above the high-band patch 752 at a distance of approximately 0.5 mm. That is, the depth of the volume 805 is approximately 0.5 mm. A dielectric constant Dₖ of the dielectric material disposed between the parasitic patches 802a-d and the high-band patch 752 may be in a range of about 4.9 to 6.0. Materials with other Dₖ values may be used. For example, the Dₖ values may be in a range of about 3.0 to about 12 in various embodiments, and dimensions may be adjusted based on gain performance. The vias 804a-d are configured to electrically couple the respective parasitic patches 802a-d to the high-band patch 752 through an interposing dielectric material. In an example, each of the vias 804a-d may be disposed at a distance of 0.04 mm from the center of the high-band patch 752. FIG. 8B includes a dimension circle 807 with a radius of 0.04 mm around the center of the high-band patch 752 to illustrate the relative locations of the parasitic patches 802a-d and the vias 804a-d.

Referring to FIGS. 8D, 8E, and 8F, example variations on parasitic patch designs are shown. A first example depicted in FIG. 8D includes a plurality of parasitic patches 808a-d with rounded corners. The parasitic patches 808a-d are substantially similar to the parasitic patches 802a-d described in FIGS. 8A-8C but include rounded corners as depicted in FIG. 8D. In an example, the curvature on the rounded corner of the parasitic patches 808a-d may be based on an arc with a 0.4 mm radius. A second example depicted in FIG. 8E includes a plurality of parasitic patches 810a-d with notched corners. The dimensions of the notches may be approximately 0.1 mm to 0.3 mm as measured from outside edges of the parasitic patches 810a-d. The notches may be square shaped (as depicted in FIG. 8E) or other geometries such as semi-circular or other polygons configured to reduce the overlap between the parasitic patch and the underlying active patch. A third example includes circular quadrant parasitic patches 812a-d disposed over the high-band patch 752. In an example, the radius of each of the parasitic patches 812a-d is approximately equal to the distance between the center and a corner of the active patch. Other patch sizes may be used.

Referring to FIG. 9A, with further references to FIGS. 7D and 8D, a top-view diagram of an example dual-band patch antenna 900 for low-band performance and increased frequency bandwidth performance in high-bands is shown. The dual-band patch antenna 900 includes an embodiment low-band patch antenna 902, such as the low-band patch antenna 750 described in FIG. 7D, and a high-band patch antenna 904, configured to provide increased bandwidth performance for relatively higher-frequency bands. The high-band patch antenna 904 may include the high-band patch 752 and the parasitic patches as described in FIGS. 8A-8F. The arrangement shown in FIG. 9A has particular advantages in dual-band performance in that the low-band patch antenna 902 may be optimized for low-band performance, such as gain over the 28 GHz band noted above, while the high-band patch antenna 904 may improve high-band performance such as gain and bandwidth in the range of 37 GHz to 43.5 GHZ, as well as the n262 band (i.e., 47.2 GHZ-48.2 GHZ). The patch antenna 904 is referred to as being high-band because it operates in a range of frequencies which are higher than the range of frequencies in which the low-band patch antenna 902 operates. As described, however, such high-band may include two (or more) bands as defined by a communication standard. Thus, the recitation of a “high-band” or “dual band” is not limiting with respect to how many communication bands, channels, etc. are included therein. The addition of the parasitic patches (e.g., parasitic patches 808a-d) and corresponding via structures (e.g., vias 804a-d) increases the bandwidth capabilities of the high-band patch antenna 904 as compared to prior high-band patch antenna systems. In other examples (not illustrated), the passive element 722 may be omitted from the dual-band patch antenna 900 or replaced by a passive (parasitic) element which does not have an inner opening (e.g., is solid) and/or the corner elements 746 and/or side elements 748 may be omitted. In some such examples, and in some other examples, the high-band patch antenna 904 and low-band patch antenna 902 are stacked (e.g., with the high band patch antenna 904 being disposed above the low-band patch antenna 902) instead of being disposed laterally adjacent one another.

Referring to FIG. 9B, a top-view illustration of an embodiment, dual-band patch antenna array 950, which includes a plurality of high-band patch antennas 956a-d, consistent with the high-band patch 752 and parasitic patches 808a-d described in FIGS. 8A-8E. The high-band patch antennas 956a-d are configured to radiate, when electrically driven, at frequencies in a relatively higher frequency band, such as the 39 GHz band and including the n262 band. The dual-band patch antenna array 950 further includes a plurality of low-band patch antennas 954a-d, each configured the same as the example low-band patch antenna 750 illustrated in FIG. 7D. The low-band patch antennas 954a-d are disposed in an interleaved arrangement with the plurality of high-band patch antennas 956a-d, in this case along a long axis 962 passing through the center of the antennas 954, 956 of the patch antenna array. Other interleaved arrangements may be provided. For example, dual-band patch array 950 is depicted in a ABAB arrangement. Other configurations may include ABBA, or BAAB. Further, a greater or lesser quantity of each of the high-band patch antennas 956 and low-band patch antennas 954 may be included in the array 950. A center-to-center separation 958 in the X axis direction, along the long axis 962, between adjacent high-band and low-band patch antennas can be about 4.6 mm in some embodiments. More generally, the center-to-center separation 958 can be in a range of about 4.0 mm to about 6.0 mm in various embodiments (e.g., half a wavelength of a 28 GHz signal, which is approximately 5.35 mm). Correspondingly, an example center-to-center separation 960 in the same direction between nearest high-band or nearest low-band patch antennas to each other can be about 9.2 mm in some embodiments, or, more generally, in a range of about 8.0 mm to about 12.0 mm in various embodiments (e.g., a wavelength of a 28 GHz signal, which is approximately 10.7 mm).

In an example, the dual-band patch antenna array 950 of high-band and low-band patch antennas is disposed on a substrate 952 (also referred to herein as a “substrate” or “dielectric substrate”), which may have a width dimension of less than 3.2 mm (e.g., to be disposed in a side mounted configuration as depicted in FIGS. 6A and 6B). Further, in some embodiments, the substrate width may be less than or equal to 3.0 mm.

The substrate 952 can be formed, in whole or in part, of a dielectric material 964. A dielectric constant Dₖ of the dielectric material 964 may be in a range of about 5.0 to 9.8. In particular embodiments, the dielectric constant Dₖ of the dielectric material may be in a range of about 4.4 to about 6.4, in a range of about 9.0 to about 9.8, or in a range of about 5.0 to about 9.8. More particular values of about 5.4 and about 9.4 have been demonstrated to be favorable for certain embodiments. More generally. Dₖ may be in a range of about 3.0 to about 12 in various embodiments, and dimensions may be adjusted accordingly.

Referring to FIG. 9C, a side-view illustration of the example dual-band patch antenna array 950 of FIG. 9B is shown. The antenna array 950 includes the low-band patch antennas 954a-d and the high-band patch antennas 956a-d disposed on or within the substrate 952 in an interleaved 1×8 example array. Each of the low-band patch antennas 954a-d includes the same components as the low-band patch antenna 750 illustrated in FIG. 7D, although other configurations of the low-band patch antenna 750 may be used as described above, and each of the high-band patch antennas 956a-d includes the components of the high-band patch 752 and parasitic patches 808a-d illustrated in FIG. 8D, although other configurations of a high-band patch antenna may be used. The substrate 952 may be operably coupled to, or integrated with, the example MMW module PCB 520 of FIG. 5. Example low-band vias 958a-b may provide signals to respective low-band patch antennas 954a-d, and high-band vias 960a-b may provide signals to respective high-band patch antennas 956a-d. The vias 958a-b. 960a-b may be configured for horizontal and vertical polarization antenna feed configurations. Other polarizations, such as dual-slant, may also be utilized. Feeds 960 may be directly connected to the high-band patch 752 or one or more feeds may be capacitively coupled to the high-band patch 752. In an example, the substrate 952 is a planar substrate with a top surface and a bottom surface, and may be coupled at one of those surfaces to another substrate 990 including one or more signal lines 966. The substrate 952 and/or the other substrate 990 may include a conductive cladding 968 (e.g., Cu, Ag) configured as a ground plane. An RFIC may be physically coupled to the other substrate 990, for example on an opposite side of the substrate 990 as the substrate 952, or may be remote from the substrates 952, 990. The other substrate 990 may comprise a printed circuit board, and the signal lines 966 may be microstrip lines configured to transfer electrical signals to and from vias and feed points of the low-band patch antennas 954a-d and of the high-band patch antennas 956a-d. For example, the signal lines 966 may be configured to couple the patch vias operably with the RFIC 516 illustrated in FIG. 5. In an example manufacturing process, the dual-band patch antenna array 950, which is interleaved, may be constructed by forming successive dielectric layers 970 on the substrate 952, and one of the successive dielectric layers 970 may be disposed between the active element (i.e., the high-band patch 752) and parasitic patches 808a-d of each high-band antenna 956a-d. In an example, the successive dielectric layers 970 may be a printed circuit board material (e.g., prepreg) with a dielectric constant Dₖ in the range of about 4.4 to about 6.4, in a range of about 5.0 to about 9.8, or in a range of about 9.0 to about 9.8. In some particular examples, Dₖ values of about 5.4 or about 9.4 have been favorably used. More broadly, the Dₖ can be in a range of about 3.0 to about 12, and dimensions may be adjusted accordingly. In some examples, the substrate 952 has a higher dielectric constant than the substrate 990. For example, the substrate 990 may have a dielectric constant in the range of 3.0-4.0 In other examples, one or more of the low-band patch antennas 954a-d and the high-band patch antennas 956a-d are included in the same substrate in which the signal lines 966 are implemented (e.g., the substrate 952 and 990 are the integrated or are the same substrate). In other examples, a substrate unique to one or more of the low-band patch antennas 954a-d and/or one or more of the high-band patch antennas 956a-d) may be implemented (e.g., separate from substrate(s) of the other antennas). In an example, the distance between the conductive cladding 968 and the high-band patch 752 is approximately 0.284 mm. The active element 702 may be included in a same layer as the high-band patch 752, as illustrated, or included in a different layer. Further, the passive element 722 may be included in a same layer as the parasitic patches 808, as illustrated, or included in a different layer.

As can be seen in FIG. 9C, the outer edges of the active element 702 of each antenna may be aligned with the outer edges of the passive element 722 of the antenna. In other embodiments, the outer edges of these elements are not aligned. The peripheral elements 746, 748 are illustrated as being disposed in a same layer as the active element 702. In other embodiments, the peripheral elements 746, 748 are disposed in a different layer than the active element 702, for example in a layer between the active element 702 and the passive element 722. In some embodiments, the peripheral elements 746, 748 are omitted. In some such embodiments, an edge of the active element 702 may have a length equal to a length between outer edges of the peripheral elements 746 in the illustrated configuration, or a size between such length and the illustrated length of the edge of the active element 702.

FIGS. 7A-9C, like the other drawings, are not necessarily to scale, emphasis instead being placed upon illustrating embodiments and general arrangements.

While the dual-band patch antenna array 950 in FIGS. 9B and 9C depicts a 1×8 array of interleaved patch antennas, other array dimensions such as 1×2, 1×4, 1×6, 1×10, etc. may be used. In an example, wider arrays of interleaved patches such as 2×2, 2×4, 2×6, 2×8, 4×4, 4×6, 4×8, 6×6, 6×8, 8×8, etc. may be used. In such embodiments, each row may include patch antennas having interleaved, low-band patch antennas such as the low-band patch antennas 954a-d, and high-band patch antennas such as the high-band patch antennas 956a-d. Each column may also be formed of patch antennas having interleaved low-band and high-band configurations. The dual-band patch antenna array 950 may be integrated in the MMW module PCB 520 of FIG. 5 or disposed on one or more antenna carriers and operably coupled to the RFIC 516 of FIG. 5 via one or more connector cables or coupling mechanisms. Various three-dimensional (3-D) solutions may also be realized such that multiple dual-band patch antenna arrays 950 may be disposed on two or more sides of a mobile device, which may correspond with the patch antenna arrays 330, 340 in FIG. 3. More than one antenna carrier assembly (i.e., multiple parts) may be used to support the dual-band patch antenna array 950. In an example, a device cover may be used as the antenna carrier. Other structures may also be used to secure radiator arrays on one or more geometric planes.

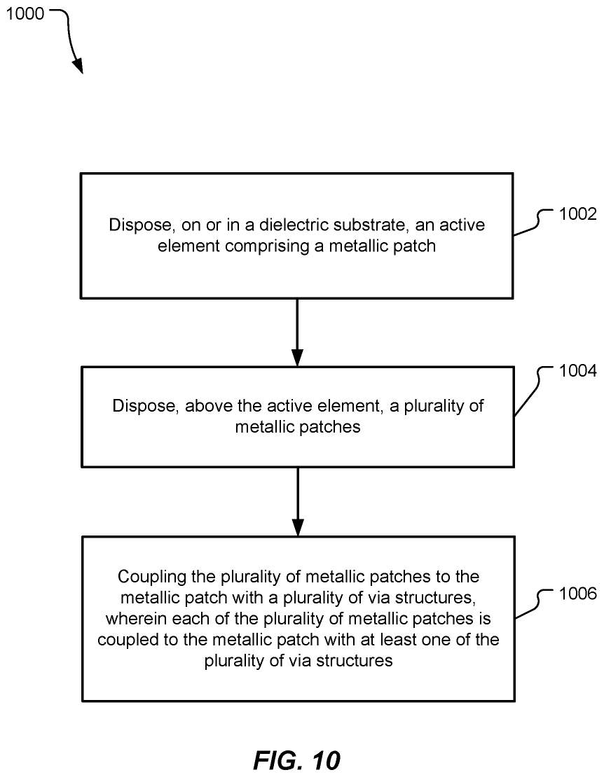

Referring to FIG. 10, a flow diagram illustrating an example procedure 1000 for manufacturing an embodiment patch antenna, such as the high-band patch 752 including the parasitic patches 802a-d, 808a-d, 810a-d, 812a-d of FIGS. 8C-8F, respectively. The procedure 1000 is, however, an example and not limiting. The procedure 1000 may be altered, e.g., by having stages added, removed, rearranged, combined, performed concurrently, and/or having single stages split into multiple stages. For example, the procedure 1000 may be modified to include implementation of the optional features noted in the summary, including for manufacturing an embodiment interleaved patch antenna array.

At stage 1002, the process includes disposing, on or in a dielectric substrate, an active element comprising a metallic patch. In an example, the active element can be the high-band patch 752 illustrated in FIGS. 8A-8F. The dielectric substrate can be the dielectric substrate 952 illustrated in FIG. 9C and may include the substrate 952 and successive dielectric layers 970 illustrated in FIG. 9C. In an example, the metallic patch is square and approximately 1.4 mm along each side.

At stage 1004, the process includes disposing, above the active element, a plurality of metallic patches. The plurality of metallic patches may be the parasitic patches 802a-d, 808a-d, 810a-d, 812a-d as illustrated in FIGS. 8A-8F. Each of the plurality of metallic patches may be substantially parallel to the active element described at stage 1002 and disposed such that each of the plurality of metallic patches are not in physical contact with one another (i.e., they are separated by a gap 806). In an example, the plurality of metallic patches are each disposed approximately 0.5 m above the active element, such as depicted in FIG. 8C. In an example, the combined surface area of the plurality of metallic patches may be within 15% of the surface area of the active patch.

At stage 1006, the process includes coupling the plurality of metallic patches to the metallic patch with a plurality of via structures, wherein each of the plurality of metallic patches is coupled to the metallic patch with at least one of the plurality of via structures. In an example, the via structures are the vias 804a-d illustrated in FIG. 8A-8F. The via structures may be comprised of copper, aluminum, or other conducting material. The maximum radius of each of the via structures may be limited by a manufacturing process and is typically about 0.04 mm. Larger vias, or additional vias, may be used to increase the conductivity between the active element and the metallic patches. The location of the vias on the active element may be modified to adjust the gain performance of the patch antenna.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements without departing from the scope of the disclosure.

Having described several example configurations, various modifications, alternative constructions, and equivalents may be used without departing from the scope of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

Implementation examples are described in the following numbered clauses:

Clause 1. A patch antenna, comprising an active element comprising a metallic patch disposed on a first plane, a plurality of metallic patches disposed on a second plane that is above and parallel to the first plane, wherein each of the plurality of metallic patches are separated from one another in the second plane by a gap, and a plurality of via structures disposed between the first plane and the second plane, wherein each of the plurality of via structures is configured to electrically couple a respective one metallic patch of the plurality of metallic patches with the active element.

Clause 2. The patch antenna of clause 1 wherein a dielectric material is disposed between the first plane and the second plane.

Clause 3. The patch antenna of clause 1 or clause 2 wherein a distance between the first plane and the second plane is between 0.4 mm and 0.6 mm.

Clause 4. The patch antenna of any of clauses 1-3 wherein the metallic patch is square and has four equilateral sides of length about 1.4 mm.

Clause 5. The patch antenna of any of clauses 1-4 wherein each of then metallic patches in the plurality of metallic patches is a square shape with each of four equilateral sides having a length of about 0.75 mm.

Clause 6. The patch antenna of any of clauses 1-4 wherein one corner of each of the metallic patches in the plurality of metallic patches has a curved shape.

Clause 7. The patch antenna of any of clauses 1-6 wherein the gap between at least two metallic patches in the plurality of metallic patches is at least 0.05 mm.

Clause 8. The patch antenna of any of clauses 1-7 wherein each of the plurality of via structures contacts the active element at an equal distance from a center of the metallic patch.

Clause 9. The patch antenna of clause 8 wherein the equal distance is between 0.3 mm and 0.4 mm.

Clause 10. A patch antenna array, comprising: a plurality of high-band patch antennas configured to radiate, when electrically driven, at frequencies in a relatively higher frequency band, wherein each patch antenna of the plurality of high-band patch antennas includes an active element, a plurality of parasitic patches disposed above the active element, and a plurality of via structures configured to electrically couple a respective one parasitic patch of the plurality of parasitic patches with the active element, and a plurality of low-band patch antennas configured to radiate, when electrically driven, at frequencies in a relatively lower frequency band, the plurality of low-band patch antennas disposed in an interleaved arrangement with the plurality of high-band patch antennas, along a long axis of the patch antenna array.

Clause 11. The patch antenna array of clause 10, further comprising a substrate on which the plurality of high-band patch antennas and the plurality of low-band patch antennas are disposed, wherein adjacent high-band and low-band antennas of the patch antenna array are situated along the long axis of the patch antenna array with center-to-center separation in a range of about 4.0 mm to about 6.0 mm.

Clause 12. The patch antenna array of clause 10 or clause 11 wherein a distance between the active element and the plurality of parasitic patches is between 0.4 mm and 0.6 mm.

Clause 13. The patch antenna array of any of clauses 10-12 wherein the active element is a square metallic patch with each of four sides having a length of about 1.4 mm.

Clause 14. The patch antenna array of clause 13 wherein each of the plurality of via structures contacts the active element at an equal distance from a center of the square metallic patch.

Clause 15. The patch antenna array of clause 14 wherein the equal distance is between 0.3 mm and 0.4 mm.

Clause 16. The patch antenna array of any of clauses 10-15 wherein each parasitic patch in the plurality of parasitic patches is a square shape with each of four sides having a length of about 0.75 mm.

Clause 17. The patch antenna array of any of clauses 10-15 wherein one corner of each of the parasitic patches in the plurality of parasitic patches has a curved shape.

Clause 18. The patch antenna array of any of clauses 10-18 wherein at least a first parasitic patch in the plurality of parasitic patches are separated from at least a second parasitic patch in the plurality of parasitic patches by a gap of at least 0.05 mm.

Clause 19. A patch antenna array, comprising: a plurality of high-band patch antennas configured to radiate, when electrically driven, at frequencies in a relatively higher frequency band, wherein each patch antenna of the plurality of high-band patch antennas includes an active element, a plurality of parasitic patches disposed above the active element, and a plurality of via structures configured to electrically couple a respective one parasitic patch of the plurality of parasitic patches with the active element; a plurality of low-band patch antennas configured to radiate, when electrically driven, at frequencies in a relatively lower frequency band, the plurality of low-band patch antennas disposed in an interleaved arrangement with the plurality of high-band patch antennas, along a long axis of the patch antenna array; wherein each low-band patch antenna of the plurality of low-band patch antennas includes: a low-band active element; and a passive element comprising a metal ring with an outer edge and an inner edge, the inner edge defining an inner opening.

Clause 20. The patch antenna array of clause 19 wherein the plurality of high-band patch antennas and the plurality of low-band patch antennas are disposed on a substrate having a width less than 3.2 mm.

Clause 21. The patch antenna array of any of clauses 10-20 wherein the plurality of high-band patch antennas and the plurality of low-band patch antennas are disposed in a first substrate coupled to a second substrate having one or more signal lines, a dielectric constant of the first substrate being higher than a dielectric constant of the second substrate.

Clause 22. The patch antenna array of any of clauses 1-9 wherein a dielectric material in which the metallic patch is disposed has a dielectric constant of greater than about 5.0.

1. A patch antenna, comprising:
an active element comprising a metallic patch disposed on a first plane;
a plurality of metallic patches disposed on a second plane that is above and parallel to the first plane, wherein each of the plurality of metallic patches are separated from one another in the second plane by a gap; and
a plurality of via structures disposed between the first plane and the second plane, wherein each of the plurality of via structures is configured to electrically couple a respective one metallic patch of the plurality of metallic patches with the active element.

2. The patch antenna of claim 1 wherein a dielectric material is disposed between the first plane and the second plane.

3. The patch antenna of claim 2 wherein the dielectric material has a dielectric constant of greater than about 5.0.

4. The patch antenna of claim 1 wherein a distance between the first plane and the second plane is between 0.4 mm and 0.6 mm.

5. The patch antenna of claim 1 wherein the metallic patch is square and has four equilateral sides of length about 1.4 mm.

6. The patch antenna of claim 1 wherein each of then metallic patches in the plurality of metallic patches is a square shape with each of four equilateral sides having a length of about 0.75 mm.

7. The patch antenna of claim 1 wherein one corner of each of the metallic patches in the plurality of metallic patches has a curved shape.

8. The patch antenna of claim 1 wherein the gap between at least two metallic patches in the plurality of metallic patches is at least 0.05 mm.

9. The patch antenna of claim 1 wherein each of the plurality of via structures contacts the active element at an equal distance from a center of the metallic patch.

10. The patch antenna of claim 9 wherein the equal distance is between 0.3 mm and 0.4 mm.

11. A patch antenna array, comprising:
a plurality of high-band patch antennas configured to radiate, when electrically driven, at frequencies in a relatively higher frequency band, wherein each patch antenna of the plurality of high-band patch antennas includes an active element, a plurality of parasitic patches disposed above the active element, and a plurality of via structures configured to electrically couple a respective one parasitic patch of the plurality of parasitic patches with the active element; and
a plurality of low-band patch antennas configured to radiate, when electrically driven, at frequencies in a relatively lower frequency band, the plurality of low-band patch antennas disposed in an interleaved arrangement with the plurality of high-band patch antennas, along a long axis of the patch antenna array.

12. The patch antenna array of claim 11, further comprising a substrate on which the plurality of high-band patch antennas and the plurality of low-band patch antennas are disposed, wherein adjacent high-band and low-band antennas of the patch antenna array are situated along the long axis of the patch antenna array with center-to-center separation in a range of about 4.0 mm to about 6.0 mm.

13. The patch antenna array of claim 11 wherein a distance between the active element and the plurality of parasitic patches is between 0.4 mm and 0.6 mm.

14. The patch antenna array of claim 11 wherein the active element is a square metallic patch with each of four sides having a length of about 1.4 mm.

15. The patch antenna array of claim 14 wherein each of the plurality of via structures contacts the active element at an equal distance from a center of the square metallic patch.

16. The patch antenna array of claim 15 wherein the equal distance is between 0.3 mm and 0.4 mm.

17. The patch antenna array of claim 11 wherein each parasitic patch in the plurality of parasitic patches is a square shape with each of four sides having a length of about 0.75 mm.

18. The patch antenna array of claim 11 wherein one corner of each parasitic patch in the plurality of parasitic patches has a curved shape.

19. The patch antenna array of claim 11 wherein at least a first parasitic patch in the plurality of parasitic patches are separated from at least a second parasitic patch in the plurality of parasitic patches by a gap of at least 0.05 mm.

20. The patch antenna array of claim 11 wherein the plurality of high-band patch antennas and the plurality of low-band patch antennas are disposed in a first substrate coupled to a second substrate having one or more signal lines, a dielectric constant of the first substrate being higher than a dielectric constant of the second substrate.
